(19) United States
(12) Patent Application Publication
(10) Pub. No.: US 2013/0097070 A1
(43) Pub. Date: Apr. 18, 2013

(54) SMART OUTLET

(71) Applicant: Raymond Bradford Baker, Harrison, OH (US)

(72) Inventor: Raymond Bradford Baker, Harrison, OH (US)

(21) Appl. No.: 13/586,928

(22) Filed: Aug. 16, 2012

Related U.S. Application Data
(60) Provisional application No. 61/548,284, filed on Oct. 18, 2011.

(51) Int. Cl. G01D 21/00; G06Q 40/02; G06Q 40/00

(52) U.S. Cl. 705/38; 705/35; 377/19

(57) ABSTRACT

A smart electrical outlet, comprising an electrical outlet, and a counter counting a unit, wherein the counter is configured to count up when a counting criterion is met, and wherein the counter is configured to stop counting up when an ending criterion is met. A smart electrical outlet, comprising an electrical outlet and a screen for communicating with a user, wherein the screen is configured to provide to a user an option of leasing the smart electrical outlet based on time of use or sell electrical power provided by the smart electrical outlet.

### CROSS REFERENCE TO RELATED APPLICATION

This patent application claims the benefit of and incorporates by reference herein the disclosure of the pending provisional application U.S. Ser. No. 61/548,284, filed Oct. 18, 2011.

### BACKGROUND

With the growth of the number of power-hungry type devices that are used by consumers, there is a growing need to have access to electrical power. In many instances, the needed power is used by consumers of these devices at various establishments without properly compensating the owners of the establishments. In many cases, small groups of patrons of these establishments huddle around the outlets that are provided in limited numbers for extended periods of time. Thereby, such users not only use power without paying for the power but also prevent other patrons from using the outlets.

In yet other circumstances, electric and hybrid-electric vehicles are becoming more commonplace. While electrical power remains less costly than hydrocarbon-based fuels, the driving range of these vehicles on electrical power alone poses challenges for long distance commuting. In many instances, a user's daily commute requires larger electric capacity than is offered. As a result of this limitation and others, electric vehicles have not been widely adopted.

In other circumstances, availability of electrical power remains a challenge for consumers when travelling. When a consumer travels from a first location to a second location, the consumer is unsure of whether electrical power will be available at the second location. For example, when driving an electric vehicle from a suburb to a downtown area, the driver cannot be sure whether an electric outlet is available to charge the vehicle's battery while the vehicle is parked at a predetermined downtown location. In another example, when a user with a personal communication or computing device, e.g., a laptop, smartphone, etc., is travelling to multiple locations, the user is uncertain whether an outlet will be available to charge the device at one of the locations.

Therefore, there exists a need to provide a smart electrical power outlet with a unique Internet protocol address that can be used by an owner of an establishment to lease the outlet based on time, sell electrical power from the outlet, and/or reserve the outlet to consumers.

### SUMMARY

In one form, a smart electrical outlet system is disclosed. The system includes a plurality of smart electrical outlets, each smart electrical outlet configured to provide to a user an option of 1) leasing the smart electrical outlet based on time of use, or 2) sell electrical power provided by the smart electrical outlet.

In yet another form, a smart electrical outlet is disclosed. The outlet includes an electrical outlet, and a screen for communicating with a user, wherein the screen is configured to provide to a user an option of 1) leasing the smart electrical outlet based on time of use; or 2) sell electrical power provided by the smart electrical outlet.

In another form, a smart electrical outlet is disclosed. The outlet includes an electrical outlet, and a counter counting a unit, wherein the counter is configured to count up when a counting criterion is met, and wherein the counter is configured to stop counting when an ending criterion is met.

### BRIEF DESCRIPTION OF DRAWINGS

FIG. 1 is a schematic diagram of an exemplary network of smart outlets according to one embodiment of the present disclosure.

FIG. 2 is a schematic diagram of an exemplary smart outlet according to one embodiment of the present disclosure.

FIG. 3 is a flow chart of a manner of use of the exemplary smart outlets according to one embodiment of the present disclosure.

FIG. 4 is a schematic of a smart outlet with an exemplary Hobbs-style meter, according to one embodiment of the present disclosure.

FIG. 5 is a flow chart of a manner of use of the exemplary smart outlet depicted in FIG. 4.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A novel smart outlet system has been developed. The smart outlet system enables owners of establishments and street plug-in outlets to lease outlets provided by the owners based on time of use of the outlets and/or power drawn from the outlets. The system further assigns a unique Internet protocol (IP) address to each outlet and further synchronizes the outlets to a consumer device identification number of the device connected to the outlet. The system further enables consumers to reserve an outlet with a unique IP address for a specific block of time by accessing a reservation system.

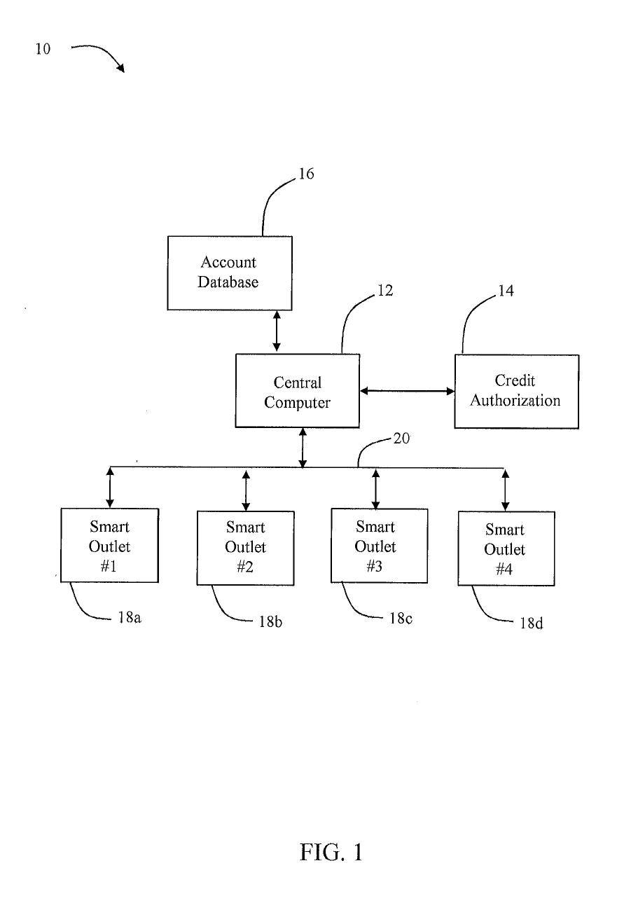

Referring to FIG. 1, a smart outlet system 10 according to at least one embodiment of the present disclosure is depicted. The smart outlet system 10 includes a central computer 12. The central computer may be constructed to include a processing unit (not shown), memory (not shown), a hard drive (not shown), and other components commonly found in a computer. The central computer 12 also includes a bus interface (not shown) for communicating with smart outlets (identified as 18a-18d, and described further below) via a bus (identified as 20 and described further below). The bus interface (not shown) may be a wired serial bus interface or a wireless serial bus interface, known to a person of ordinary skill in the art. Data from the smart outlets (identified as 18a-18d) is communicated to the central computer 12 via the bus interface (not shown). Since multiple smart outlets (identified as 18a-18d) may communicate with the central computer 12 at the same time, a priority scheme known to a person of ordinary skill in the art may be implemented to avoid corruption or loss of data. In such a priority scheme, each smart outlet will be in communication with the central computer 12 without another smart outlet sending data on the bus 20 at the same time.

The central computer 12 may be configured to be in communication with a credit authorization system 14 as well as an account database 16. The communication between the central computer 12 and the credit authorization system 14 may be a two-way communication for sending and receiving data therebetween. The credit authorization system 14 may be a server and a processor configured to process and authorize a credit card that has been swiped at a smart outlet (described further below) or at the central computer 12 (also described further below).

Similarly, the communication between the central computer 12 and the account database 16 may also be a two-way communication for sending and receiving data therebetween. A data exchange may take place between the central computer 12 and the account database 16 for keeping track of usage of the outlets, synchronizing the outlets with devices connected to the outlets and for other miscellaneous accounting purposes (described in further detail below). The account database 16 may be housed in a server with a processing unit, including memory in the form of a hard drive, electronic memory, optical storage device, etc,

Also depicted in FIG. 1 is a plurality of smart outlets 18a, 18b, 18c, and 18d (identified as smart outlets #1, #2, #3, and #4). As described above, the smart outlets 18a-18d communicate with the central computer 12 via the bus 20. The bus 20 may be configured to provide power (i.e., electrical current at a specified voltage) and data. The bus 20 may be any combination of electrical wires, radio frequency channels, and fiber optics. Electrical wires may be in the form of power-carrying wires, coaxial wires, telephone wires, etc. While each smart outlet of the plurality of outlets 18a-18d is coupled to the central computer, the smart outlets 18a-18d are also coupled to each other by way of the bus 20. In the form of electrical wires, the smart outlets 18a-18d each may be configured to encode communication with a codex representative of the outlet's IP address, The IP addresses may be assigned by the central computer 12 or by another computing device, e.g., an internet service provider computing device. Therefore, each outlet of the plurality of outlets 18a-18d may be assigned a unique code (i.e., an IP address) that can be accessed via the internet via the bus 20. For example, the data that is communicated between each of the smart outlets 18a-18d and the central computer 12 may be in the form of digital data that is prefixed by IP address for the outlet in predefined data packets to avoid mixing of data between the smart outlets 18a-18d. The encoding may be accomplished by placing data on the electrical wires (e.g., using a carrier with a modulation frequency well apart from the frequency of alternating current provided on the power lines), the coaxial cables, fiber optical cables, or via wireless channels.

It should be appreciated that while four smart outlets 18a-18d are shown, more or less outlets may form the smart outlet system 10 that is depicted in FIG. 1, In particular, there may be hundreds and thousands of these outlets in a network or as few as one.

It should also be appreciated that while a central network of smart outlets 18a-18d with a central computer 12 is depicted in FIG. 1, the network may also be a distributed network of smart outlets 18a-18d without a central computer 12. In such a distributed network, the tasks of the central computer 12, described above, are accomplished by individual smart outlets. For example, each smart outlet may be configured to communicate with the credit authorization system 14. In order for each of the smart outlets to communicate directly with the credit authorization system 14, each smart outlet may be outfitted with a communication device configured for communicating with the credit authorization system 14. Similarly, each smart outlet may be configured to communicate with the account database 16. Since multiple smart outlets (identified as 18a-18d) may communicate with the account database 16 at the same time, a priority scheme known to a person of ordinary skill in the art may be implemented to avoid corruption or loss of data. In such a priority scheme, each smart outlet will be in communication with the account database 16 without another smart outlet sending data on the bus 20 at the same time.

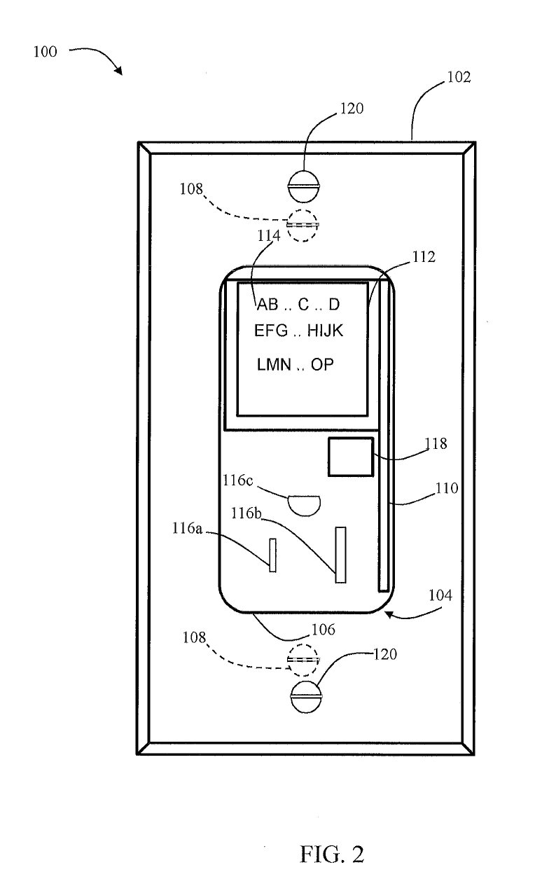

Referring to FIG. 2, a schematic of a smart outlet 100 according to one embodiment of the present disclosure is depicted. The smart outlet 100 includes a coverplate 102 and a plug assembly 104. The plug assembly 104 includes a body 106, fastening members 108, and a credit card swipe slot 110. The body 106 is generally made from an electrically insulating material such as plastic, porcelain, etc. The body 106 is generally rectangular in shape with sufficient length to accommodate various components on the body 106 as described further below and yet sufficiently small so as to fit within a standard size electrical enclosure. The body 106 is mounted to an electrical enclosure (not shown), e.g., a gangbox, by the fastening members 108 which are separated from one another based on generally accepted dimensions for common electrical enclosures. The fastening members 108 are depicted in phantom since these are configured to be behind the coverplate 102 in the assembled position. Connecting members (not shown) with matching holes are coupled to the body 106 and are configured to mount the body 106 to the electrical enclosure (not shown) with the fastening members 108.

The body 106 also includes the credit card swipe slot 110 which may be formed to protrude out of the body 106 or be completely flush with the body 106. In one form (the protruded form), the credit card swipe slot 110 includes protruding lips (not shown) that would come out of the page and be perpendicular to the body 106. These protruding lips (not shown) would be configured to allow a user to swipe the magnetic strip of a credit card as the card is moved from the top of the protruding lips (not shown) to the bottom. The protruding lips (not shown) would include magnetic readers to obtain information from the magnetic strip of the credit card. While the credit card swipe slot 110 is depicted in FIG. 2, it should be appreciated that the smart outlet 100 may be provided without the credit card swipe slot 100. Instead, the function provided by the credit card swipe slot 100 may be provided at the central computer 12 or not all.

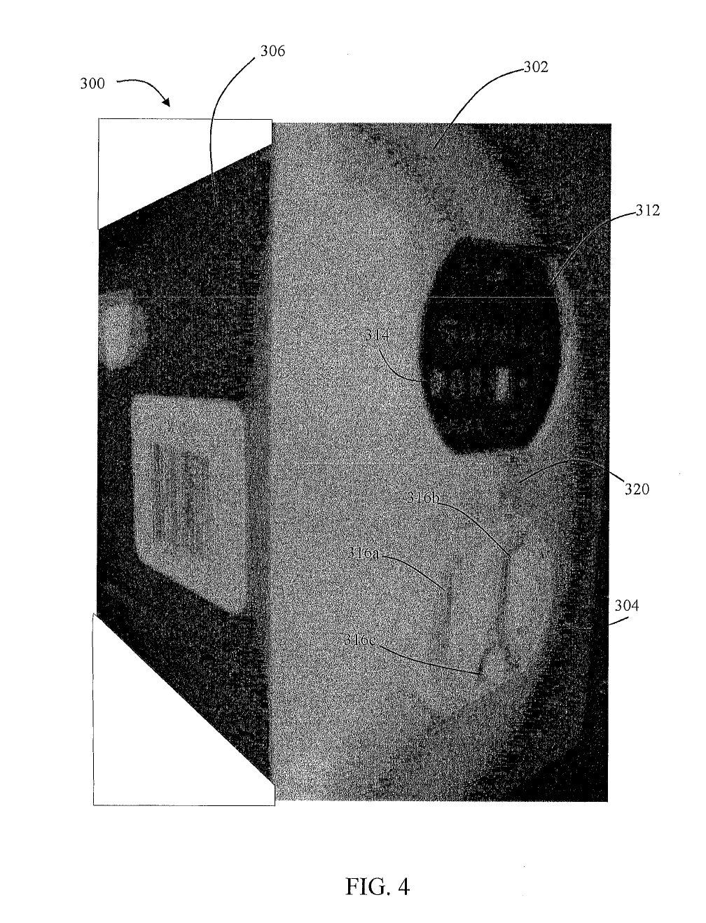

The body 106 also includes a screen 112 (e.g., a liquid crystal display) positioned in the upper portion of the body. The screen 112 may be a touch screen allowing a user to provide inputs by touching the screen 112 in response to questions asked by text 114 that appear on the screen 112. Alternatively, the screen 112 may be solely an output device configured to provide information to a user. The screen 112 may also be substituted in alternative embodiments with other output devices such as light emitting diodes, a counter, and the like. An alternative embodiment of a smart outlet 300 is depicted in FIG. 4, described further below, including a meter 312 with analog-type numbers 314 that can be used to indicate an amount of time a device is plugged into the smart outlet 300, or an amount of power provided by the smart outlet 300.

The body 106 also includes a set of electrical outlets 116a, 116b, and 116c. The outlets 116a and 116b are polarized outlets while outlet 116c is for a matching ground pin. In other embodiments, the outlets 116a and 116b may be non-polarized. In yet another embodiment, the ground outlet 116c may be avoided. The body 106 may have a ground fault associated circuit (not shown) that results in the outlets 116a, 116b, and 116c becoming a ground fault interrupt outlet, known to a person of ordinary skill in the art. In such an embodiment, the ground fault associated circuit (not shown) is configured to interrupt flow of current through the outlets 116a and 116b when a ground fault is sensed. The body 106 may also include a current sensing circuit (not shown) configured to 1) interrupt flow of current through the outlets 116a and 116b when the current passes above an upper threshold; or 2) limit the current flowing through the outlets 116a and 116b to the upper threshold. Either of these actions may be taken in order to prevent an associated circuit breaker (not shown) from tripping requiring a manual resetting of the circuit breaker (not shown).

Referring to FIG. 2, the body 106 also includes an optional Ethernet connection 118. The Ethernet connection 118 provides a hard-wire connection between a device (not shown) that is connected to the smart outlet 100 and the outlet 100. The Ethernet connection 118 can be used to communicate data such as device identification of the device (not shown) as well as general communication of data between the smart outlet 100 and the device (not shown). Alternatively or in addition to, the smart outlet 100 can include a wireless transceiver (not shown) configured to communicate with the device (not shown).

The coverplate 102 also includes two fastening members 120 configured to connect the coverplate 102 to the body 106.

While only one set of outlets 116a, 116b, and 116c is depicted in FIG. 2, the body 106 may be configured to allow two sets of outlets (not shown). The screen 112 may be sized to allow the second set of outlets according to customary spacing between the outlets.

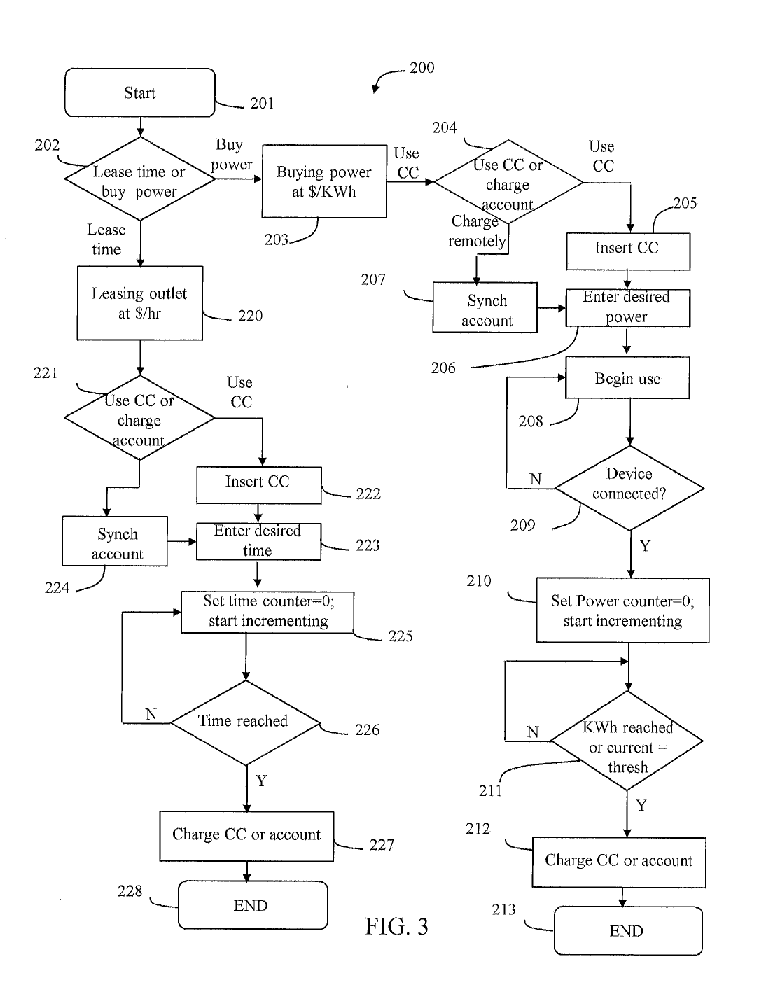

Referring to FIG. 3, a flow chart 200 defining operational aspects of the smart outlet 100 is depicted according to at least one embodiment of the present disclosure. It should be appreciated that these operational aspects are based on queries and responses that are either provided at the smart outlet 100 or at the central computer 12 (e.g., a kiosk, depicted in FIG. 1).

In at least one embodiment of the present disclosure, the flowchart begins at the “Start” state in step 201. In at least one embodiment of the present disclosure, the smart outlet 100 can be configured to be leased based on time of use, or based on power that is delivered from the smart outlet 100. It should be appreciated that the smart outlet 100 may support both models. However, it should be appreciated that in some circumstances, a smart outlet 100 may only be leased based on time of use and/or only configured to be used to deliver a certain amount of power.

In at least one embodiment of the present disclosure, after the “Start” state, a user is queried to determine whether the smart outlet 100 is to be leased (i.e., based on time of use) or based on purchasing power in step 202. In at least one embodiment of the present disclosure, the smart outlet 100 is pre-set to either be leased or based on power purchased. In at least one embodiment of the present disclosure, if the user responds with the desire to lease the outlet, the smart outlet 100 displays a rate of use to be paid by the user of dollars per hour ($/hr) in step 220. In at least one embodiment of the present disclosure, the smart outlet 100 may be configured to charge any currency in any measure of time, such as, for example, pounds per minute, pesos per second, and otherwise. It should be appreciated that the smart outlet 100 may be configured for a variable rate taking into account various factors, such as, for example, demand for use of the smart outlet 100, historical usage of the smart outlet 100, and/or time of day.

In at least one embodiment of the present disclosure, after the user selects to lease the smart outlet 100 at a rate, the user is queried as to whether the user wishes to pay for consumption through credit card or charge an account in step 221, In at least one embodiment of the present disclosure, the user may select to charge a known account to the smart outlet 100, a general tab with the facility in which the smart outlet 100 is located, a PayPal account, or another account in which the smart outlet 100 may automatically deduct funds and/or accumulate a bill for usage of the smart outlet 100 at the rate.

In at least one embodiment of the present disclosure, if the user responds by desire to charge using a credit card, then the smart outlet 100 displays a message for the user to insert the credit card in step 222. In at least one embodiment of the present disclosure, if the user responds by selecting to charge an account, an account synchronization scheme is executed at step 224. In at least one embodiment of the present disclosure, the synchronization scheme allows for pairing of a device to an account by matching a device identification number or some other identification number to an account. In another embodiment, the user may input account credentials, such as, for example, a Paypal account name and password in step 224. In at least one embodiment of the present disclosure, the user may input a single number or account information provided by the establishment in which the smart outlet 100 is located in step 224. It should be appreciated that the synchronization step 224 allows the user to simply plug in any device and use the smart outlet 100 without the need to pre-pay the rate for the smart outlet 100.

In at least one embodiment of the present disclosure, after the user inserts a credit card in step 222 or syncs usage with an account in step 224, the user is asked to enter amount of time the user wishes to lease the smart outlet in step 223. In at least one embodiment of the present disclosure, the user may enter a time in seconds, hours, days, or another timing metric. It should be appreciated that the user may select any time in which to lease the smart outlet 100. In at least one embodiment of the present disclosure, the amount requested by the user in step 223 may be evaluated against the account in which the user selected to sync payment in step 224 or the credit card that the user input in step 222. In the event that the user's account or credit card does not have sufficient funds in order to pay for the desired time requested in step 223, the smart outlet 100 may prompt the user to enter a different time or otherwise produce an error.

In at least one embodiment of the present disclosure, if the desired time is accepted, a timer is reset and the timer then begins to count toward the requested lease time in step 225. In the event that the timer reaches the desired time, the smart outlet 100 is disabled in step 226.

In at least one embodiment of the present disclosure, the credit card or the account is charged in step 227. It should be appreciated that the credit card or the account may be charged after the desired time is reached in step 226 or before the desired time is reached. For example, the smart outlet 100 may be configured to charge the user's credit card or account in step 227 immediately after the user enters the desired time in step 223, a configurable time period when the time counter is incrementing in step 225, upon reaching the desired time in step 226, or another time that is configured.

In at least one embodiment of the present disclosure, after the credit card or account is charged, the smart outlet 100 enters the “End” state in step 228. It should be appreciated that the “End” state may reset the smart outlet 100 to the “Start” state identified by step 201. In at least one embodiment of the present disclosure, the “End” state in step 228 and the “Start” state in step 201 are the same state.

In at least one embodiment of the present disclosure, a user may select to purchase power directly in step 202. In such an embodiment, instead of leasing the smart outlet 100 at a rate the user selects to pay for power consumed in step 202. As discussed above, after the “Start” state, the user is queried whether the outlet is to be leased (i.e., based on time of use) or used based on purchasing power. If the user responds with desire to purchase power or the smart outlet 100 is preconfigured to only accept purchases of power, a cost of power at a rate of use is displayed in step 203. It should be appreciated that the cost of power displayed in step 203 may be determined based on the locality in which the smart outlet 100 is located. For example, the cost of power displayed in step 203 may be displayed in dollars per kilowatt-hour ($/KWh), Euros per KWh, cents per KWh, or another metric.

In at least one embodiment of the present disclosure, after the user selects to purchase power in step 203, the user is queried to determine how to process payment, either through a credit card or to a charge account in step 204. In at least one embodiment of the present disclosure, if the user selects to pay for power using a credit card in step 204, then the smart outlet 100 displays a message to the user to insert a credit card in step 205. In at least one embodiment of the present disclosure, if the user chooses to process payment by charging an account in step 204, the account synchronization scheme is executed in step 207. It should be appreciated that the steps 204, 205, and 207 for the user to determine how to provide payment in the event the user purchases power may be substantially similar to steps 221, 222, and 224 in the event that the user elects to lease power.

In at least one embodiment of the present disclosure, after the user inputs acceptable means to process payment, the user is queried to enter an amount of power the user wishes to purchase from the smart outlet 100 in step 206. It should be appreciated that the user may input any amount of power to be purchased from the smart outlet 100. In at least one embodiment of the present disclosure, the user may enter the amount of currency which the user wishes to pay for power in step 206 instead of inputting the amount of power the user wishes to purchase. In such an embodiment, the smart outlet 100 will determine how much power the user is able to purchase for the amount of payment the user input in step 206. In at least one embodiment of the present disclosure, the amount of power requested by the user or the amount of payment entered by the user in step 206 may be evaluated against the account in which the user selected to sync payment in step 207 and/or the user's credit card input in step 205. In the event that the user's account or credit card does not have sufficient funds in order to pay for the desired power or payment requested in step 205, the smart outlet 100 may prompt the user to enter a different amount or otherwise produce an error.

In at least one embodiment of the present disclosure, the user may begin use of the smart outlet 100 after inputting a payment method in step 208. In such an embodiment, the smart outlet 100 attempts to determine whether the user connects a device in step 209.

In at least one embodiment of the present disclosure, the smart outlet 100 senses power is being drawn by the user, and a counter indicating amount of power delivered is reset (i.e. set to zero) and the counter then begins to count toward the requested power or amount of power purchased in step 210. In at least one embodiment of the present disclosure, in the event that the counter reaches the desired power level, the amount of power purchased, or the smart outlet 100 senses a reduction of current draw below a specified threshold, the smart outlet 100 is disabled in step 211. It should be appreciated that the threshold may indicate that the user's device has been disconnected from the smart outlet 100, and the user is no longer using the smart outlet 100. In at least one embodiment of the present disclosure, the threshold may be a configurable parameter. In an alternative embodiment, the threshold may be dynamically generated based on the rate of power consumed by the user's device detected in step 210. In such an embodiment, the smart outlet 100 is disabled in the event that the power draw falls below the rate of power consumption expected by the user's device as identified in step 209.

In at least one embodiment of the present disclosure, the credit card or the account is charged in step 212. It should be appreciated that the credit card or the account may be charged after the desired power is obtained or the rate in which power is consumed falls below the threshold in step 211 or before. For example, the smart outlet 100 may be configured to charge the user's credit card or account in step 211 immediately after the user enters the desired amount of power or payment in step 206, a configurable time period when the counter is incrementing in step 210, upon reaching the desired power or falling below the threshold in step 211, or another time that is configured.

In at least one embodiment of the present disclosure, after the credit card or account is charged, the smart outlet 100 enters the “End” state in step 213. It should be appreciated that the “End” state may reset the smart outlet 100 to the “Start” state identified by step 201. In at least one embodiment of the present disclosure, the “End” state in step 213 and the “Start” state in step 201 are the same state.

In at least one embodiment of the present disclosure, the method 200 is looped for each user connecting to the smart outlet 100 with the initial state of the smart outlet 100 being the “Start” state in step 201, and either “End” state in step 228 or step 213 reverting the smart outlet 100 back to the “Start” state in step 201.

It should be appreciated that with either of the use models, the smart outlet 100 can be configured to display usage of the smart outlet 100. According to the present disclosure, usage may be, but is not limited to, the amount of power consumed, the amount of time the smart outlet 100 has been used, the total amount of power consumed by users over a configurable amount of time, the total amount of revenue generated by the smart outlet 100, and other statistics. For example, if the outlet is leased by a user, the display (e.g., display 112 depicted in FIG. 2) can be configured to display time of use down to tenths of hours (or other desired time increment). Similarly, if the outlet is used to purchase power, the display (e.g., display 112 depicted in FIG. 2) can be configured to display used power down to tenths of KWh.

In addition to the schemes discussed above, the smart outlet system 10 may be used by a user to reserve a smart outlet at a particular location. The reservation of a smart outlet can be made possible, since every smart outlet 100 may be assigned a unique IP address and thereby identified remotely. For example, a user traveling from a suburb to a downtown location may, using the Internet, access the central computer 12 and reserve a smart outlet 18a (depicted in FIG. 1) between the hours of 8:00 AM and 10:00 AM, It should be appreciated that a smart outlet may be reserved by a user in any configurable time, such as, for example, by minutes, hours, seconds, or otherwise on a configurable date. It should be appreciated that a user may repeatedly reserve a smart outlet throughout a schedule, such as, for example, daily, weekly, monthly, or another configurable schedule. For example, a user traveling from a suburb to a downtown location on every business day may, using the Internet, access the central computer 12 and reserve a smart outlet 18a (depicted in FIG. 1) between the hours of 8:00 AM and 10:00 AM on Monday, Tuesday, Wednesday, Thursday, and Friday of the upcoming week.

In at least one embodiment of the present disclosure, to reserve a smart outlet, the user is required to enter payment information, such as, for example, a credit card or account to sync payment. In such an embodiment, the smart outlet system 10 may charge the user a minimum amount in the event that the user does not use the reserved smart outlet during the reservation window. In another embodiment, the smart outlet system 10 may charge the user for the full price of the time period that the user reserves the smart outlet or for the amount of power reserved by the user for the smart outlet.

It should be appreciated that smart outlets may be provided at various establishments, curbside, park meters, coffee houses, temporary office spaces, or any place in which regular outlets may be provided. In at least one embodiment of the present disclosure, smart outlets may be linked to a parking spot, allowing the user to pay for the use of the smart outlet while also reserving a spot in a crowded downtown area, either at a combined rate or individual rates. In such an embodiment, the reservation system allows the user to solve parking and power consumption needs in one location. For example, range of electric vehicles can be arranged based on the premise that a vehicle's battery has to only have sufficient capacity to travel one way from a suburb to a downtown location before being charged again. This reduction in battery capacity translates to a smaller and lighter battery which may extend the driving range of electrical or hybrid vehicles.

The smart outlet 300, briefly discussed above, and depicted in FIG. 4 is another embodiment of a smart outlet. The smart outlet 300 includes a coverplate 302 and a plug assembly 304. The plug assembly 304 is mounted to an electrical enclosure 306, e.g., a gangbox, by the fastening members (not shown) which are separated from one another based on generally accepted dimensions for common electrical enclosures.

The plug assembly 304 also includes a meter 312. The meter 312 may be a Hobbs-style meter providing a measure of a unit indicated by the numbers 314. The meter 312 may be configured to begin counting as soon as a device is connected to the smart outlet 300. Alternatively the counter 312 may be configured to start counting as soon as there is an electrical current draw out of the smart outlet 300. The counter 312 may be configured to count time with a resolution down to tenths of hours (or other desired time increment). Alternatively, the counter may count power usage with a resolution down to tenths of KWh (or other desired power increment). The counter 312 may be reset to zero at the smart outlet 300 or it may be reset to zero at a remote location. It should be appreciated that the smart outlet 300 can be used in connection with the smart outlet network 10 that is depicted in FIG. 1.

The plug assembly 304 also includes a set of electrical outlets 316a, 316b, and 316c. The outlets 316a and 316b are polarized outlets while outlet 316c is for a matching ground pin. In other embodiments, the outlets 316a and 316b may be non-polarized. In yet another embodiment, the ground outlet 316c may be avoided. The plug assembly 304 may include a ground fault associated circuit (not shown) that results in the outlets 316a, 316b, and 316c becoming a ground fault interrupt outlet, known to a person of ordinary skill in the art. In such an embodiment, the ground fault associated circuit (not shown) is configured to interrupt flow of current through the outlets 316a and 316b when a ground fault is sensed. The plug assembly 304 may also include a current sensing circuit (not shown) configured to 1) interrupt flow of current through the outlets 316a and 316b when the current passes above an upper threshold; or 2) limit the current flowing through the outlets 316a and 316b to the upper threshold. Either of these actions may be taken in order to prevent an associated circuit breaker (not shown) from tripping requiring a manual resetting of the circuit breaker (not shown).

Referring to FIG. 4, the plug assembly 304 also includes an optional Ethernet connection (not shown). The Ethernet connection (not shown) provides a hard-wire connection between a device (not shown) that is connected to the smart outlet 300 and the outlet 300. The Ethernet connection (not shown) can be used to communicate data such as device identification of the device (not shown) as well as general communication of data between the smart outlet 300 and the device (not shown). Alternatively or is addition to, the smart outlet 300 can include a wireless transceiver (not shown) configured to communicate with the device (not shown). In at least one embodiment of the present disclosure, the coverplate 302 includes fastening members 320 configured to connect the coverplate 302 to the plug assembly 304.

While only one set of outlets 316a, 316b, and 316c is depicted in FIG. 4, the plug assembly 304 may be configured to allow two sets of outlets (not shown) or any set of outlets. The counter 312 may be sized to allow the second set of outlets according to customary spacing between the outlets.

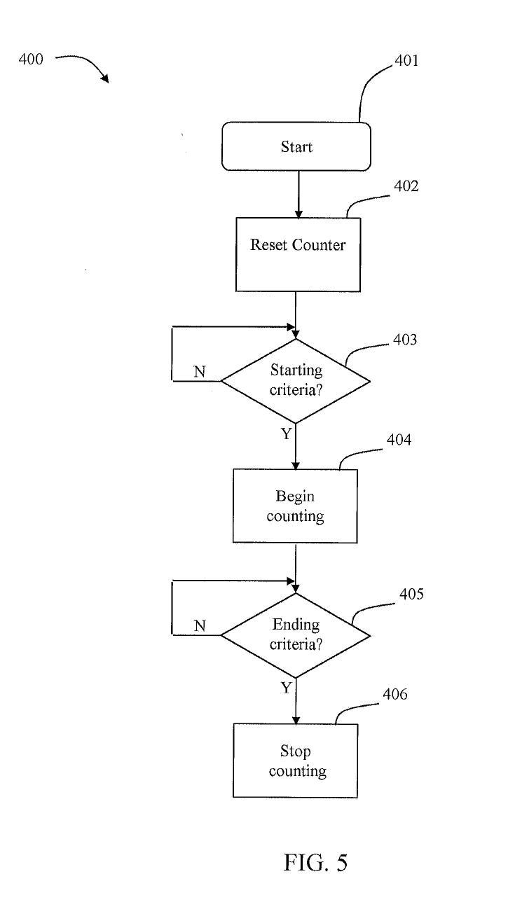

Referring to FIG. 5, a flow chart 400 defining operational aspects of the smart outlet 300 is depicted according to at least one embodiment of the present disclosure. The flowchart 400 begins at the “Start” state in step 401. In at least one embodiment of the present disclosure, either remotely (e.g., by the central computer 12 in the form of a kiosk, depicted in FIG. 1) or by adjusting the counter 312 at the smart outlet 300, the counter 312 is reset to zero in step 402. In an alternative embodiment, the counter is never reset and a count from a previous use is stored in a memory locally on the smart outlet 312 or remotely so that a difference between the counts can be used for charging purposes.

In at least one embodiment of the present disclosure, once a starting criterion has been met, e.g., plugging of a device, drawing current out of the smart outlet 300, etc., the counter 312 begins to count in step 404. In at least one embodiment of the present disclosure, once an ending criterion is reached (e.g., unplugging of a device) as determined in step 405, the counter 312 stops to count in step 406. In at least one embodiment of the present disclosure, optionally, the counter 312 may be placed in a locked state, with the smart outlet 300 disabled, until the counter 312 is properly reset in step 406.

It should be appreciated that the count arrived in step 406 may be used for charging purposes. For example, if time is being counted, then an amount for time-based use of the smart outlet 300 will be charged to a credit card or an account, as previously discussed. If power is being counted, then an amount for power-based use of the smart outlet 300 will be charged to the credit card or the account, as previously discussed.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A smart electrical outlet system comprising:
A smart electrical outlet configured to provide to a user an option of leasing the smart electrical outlet based on at least one of time of use or amount of electrical power provided by the smart electrical outlet.

2. The smart electrical outlet system of claim 1, wherein the smart electrical outlet is a plurality of smart electrical outlets.

3. The smart electrical outlet system of claim 2, wherein each smart electrical outlet is connected to another smart electrical outlet by one of a wireless bus, a wired bus, a fiber optical bus, and an electrical power bus.

4. The smart electrical outlet system of claim 2, further comprising:
a central computer coupled to the smart electrical outlet and the second smart electrical outlet; and
an interface to a credit authorization system; wherein the central computer obtains credit card information from a user of each of the smart electrical outlets and communicates charging information with the credit authorization system.

5. The smart electrical outlet system of claim 2, further comprising:
a central computer coupled to each of the smart electrical outlets; and
an interface to an account database; wherein the central computer obtains account information from a user of each of the smart electrical outlets and communicates charging information with an account database.

6. The smart electrical outlet system of claim 2, further comprising:
a central computer coupled to each of the smart electrical outlets;
an interface to a credit authorization system; and
an interface to an account database; wherein the central computer obtains 1) credit card information; or 2) account information from a user of each of the smart electrical outlets and communicates charging information with 1) a credit authorization system, or 2) an account database accordingly.

7. The smart electrical outlet system of claim 2, wherein each of the smart electrical outlets is uniquely identifiable by an Internet protocol address.

8. The smart electrical outlet system of claim 6, wherein each of the smart electrical outlets with the unique identification number can be reserved for use by accessing a reservation system.

9. A smart electrical outlet, comprising:
an electrical outlet; and
a screen for communicating with a user, wherein the screen is configured to provide to a user an option of leasing the smart electrical outlet based on at least one of time of use or amount of electrical power provided by the smart electrical outlet.

10. The smart electrical outlet of claim 9, further comprising:
a wireless interface configured to communicate data associated with 1) account information, and 2) power usage.

11. The smart electrical outlet of claim 10, further comprising:
a credit card swipe device configured to read magnetic strips of credit cards.

12. The smart electrical outlet of claim 9, further comprising:
a wired interface configured to communicate data associated with 1) account information, and 2) power usage.

13. The smart electrical outlet of claim 9, further comprising:
a ground fault circuit, configured to interrupt flow of electrical power when a ground fault is sensed.

14. The smart electrical outlet of claim 9, further comprising:
a current sensing circuit configured to 1) interrupt flow of current, or 2) limit flow of current when a current threshold is reached.

15. A smart electrical outlet, comprising:
an electrical outlet; and
a counter counting a unit,
wherein the counter is configured to count up when a counting criterion is met, and
wherein the counter is configured to stop counting when an ending criterion is met.

16. The smart electrical outlet of claim 15, wherein the counter can be reset to zero,

17. The smart electrical outlet of claim 15, wherein the counter is configured to count time.

18. The smart electrical outlet of claim 15, wherein the counter is configured to count power usage.

19. The smart electrical outlet of claim 15, wherein the counting criterion is met commensurate with plugging of a device into the smart outlet.

20. The smart electrical outlet of claim 15, wherein the counting criterion is met commensurate with an amount of electrical current drawn out of the smart outlet rising above a threshold.

21. The smart electrical outlet of claim 15, wherein the ending criterion is met commensurate with an amount of electrical current drawn out of the smart outlet falling below a threshold.

22. The smart electrical outlet of claim 15, wherein the ending criterion is met commensurate with unplugging of a device from the smart outlet.
